(19) United States
(12) Patent Application Publication
(10) Pub. No.: US 2008/0256400 A1
(43) Pub. Date: Oct. 16, 2008

(54) System and Method for Information Handling System Error Handling

(76) Inventors: Chih-Cheng Yang, Taipei City (TW); Yung Shun Liang, Taipei City (TW)

Correspondence Address: HAMILTON & TERRILE, LLP, P.O. BOX 203518, AUSTIN, TX, 78720, US

(21) Appl. No.: 11/735,531

(22) Filed: Apr. 16, 2007

(51) Int. Cl. G06F 11/30

(52) U.S. Cl. 714/57

(57) ABSTRACT

Non-fatal errors at an information handling system link are managed by firmware of the information handling system. For example, a PCI Express link controller initiates an SMI interrupt upon detection of a non-fatal error associated with the PCI Express link. A non-fatal error monitor associated with an SMI handler in the BIOS of the information handling system receives the interrupt, determines the component of the information handling system associated with non-fatal error and issues an error message if the non-fatal error meets a predetermined condition, such as a predetermined number of errors associated with the component.

### BACKGROUND OF THE INVENTION

1. Field of the Invention

The present invention relates in general to the field of information handling systems, and more particularly to a system and method for information handling system error handling.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems are typically built from a variety of standardized components that cooperate to perform desired functions. Coordination of component operations is typically performed with firmware running on a chipset, usually known as a Basic Input/Output System (BIOS), and an operating system, such as WINDOWS. The various components typically include error handling functions that manage errors that arise during operations. As an example, PCI Express errors associated with a PCI Express controller and bus are classified as correctable errors and uncorrectable errors. Correctable errors can be corrected by hardware of the PCI Express controller. Uncorrectable errors are further classified as fatal errors and non-fatal errors. Fatal errors cause the PCI Express link to be unreliable while non-fatal errors cause the particular transaction to be unreliable but the PCI Express link itself remains fully functional. The operating system, device drivers and BIOS generally handle fatal errors and fatal error reporting in an acceptable manner; however, non-fatal errors are typically just handled by reporting the error to the end user.

A number of difficulties arise with conventional management of non-fatal errors. One difficulty is that reports provided to the end user are not user friendly, often leading to end user confusion and unnecessary queries for technical support. Technical support queries increase maintenance costs for information technology specialists of an enterprise who support information handling systems as well as for the manufacturer of the information handling system. Another difficulty is that non-fatal error reports from Linux stay at a root port level and are not communicated to downstream devices. This makes the non-fatal error reports unavailable or difficult to attain at a system management level, such as for troubleshooting. For example, non-fatal errors are sometimes indicative of hardware, firmware or software problems that are otherwise difficult to identify. Non-fatal errors, in some instance, help to predict fatal errors that subsequently occur in an information handling system, such as where a failing hardware system eventually fails.

### SUMMARY OF THE INVENTION

Therefore a need has arisen for a system and method which makes non-fatal component errors available at a system management level.

In accordance with the present invention, a system and method are provided which substantially reduce the disadvantages and problems associated with previous methods and systems for managing non-fatal component errors. Non-fatal errors associated with an information handling system link are forwarded from the link controller to system firmware with an interrupt that allows an error handler of the firmware to track non-fatal errors. The error handler issues an error message associated with the non-fatal error under a predetermined condition, such as a predetermined number of non-fatal errors associated with a component interfaced with the link.

More specifically, an information handling system has plural processing components, at least some of which interface through a PCI Express link managed by a PCI Express controller. The PCI Express controller detects non-fatal errors for communications sent through the link and, upon detection of a non-fatal error, issues an interrupt. An SMI error handler associated with the BIOS firmware of the information handling system receives the interrupt and queries the error event source to determine the end point component interfaced with the PCI Express link that is associated with the error. A non-fatal error monitor, such as firmware associated with the SMI error handler, tracks the number of non-fatal errors and their association with components. If a predetermined condition exists, such as a predetermined number of non-fatal errors associated with a component, then the non-fatal error monitor issues an error message. For example, an error message issued to the operating system is presented at a display of the information handling system. As another example, an error message is forwarded to a BMC to provide notice of the non-fatal error to a management application interfaced through a network.

The present invention provides a number of important technical advantages. One example of an important technical advantage is that non-fatal errors associated with an information handling system link are automatically tracked to help predict failure of an information handling component. By counting non-fatal errors associated with a component to a threshold value, imminent failure of that component is predicted so that effective notice of the pending failure is provided to an end user. Making non-fatal error information detected at a link controller available to BIOS firmware and operating system drivers and management applications allows useful analysis of the non-fatal information at a system level. System level analysis of non-fatal errors improves the end user experience by limiting non-fatal error messages until the non-fatal errors warrant end user attention.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system having BIOS-based management of non-fatal PCI Express link errors;

FIG. 2 depicts a flow diagram of a process for managing non-fatal errors associated with an information handling system link; and

FIG. 3 depicts a flow diagram of a process for managing non-fatal errors of a PCI Express link by a blade server information handling system BIOS and operating system.

### DETAILED DESCRIPTION

Management of non-fatal link errors through an information handling system BIOS and operating system improves information handling system reliability with more simple end user interactions. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

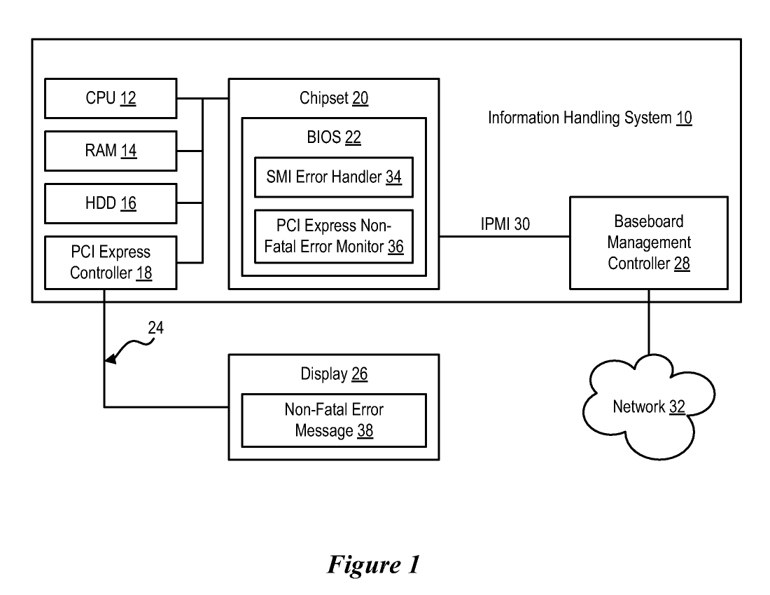

Referring now to FIG. 1, a block diagram depicts an information handling system 10 having BIOS-based management of non-fatal PCI Express link errors. Information handling system 10 has plural processing components that cooperate to process information, such as a CPU 12, RAM 14, a hard disk drive (HDD) 16, a PCI Express controller 18 and a chipset 20. A BIOS 22 resides in firmware of chipset 20 to coordinate the operation of the processing components in cooperation with an operating system running on CPU 12, such as WINDOWS or LINUX. PCI Express controller 18 manages a PCI Express link 24 that communicates information between one or more of the processing components as well as external devices, such as a display 26. In the example embodiment depicted by FIG. 1, information handling system 10 is a blade server that is managed by a baseboard management controller (BMC) 28 interfaced with the processing components through an IPMI link 30 and interfaced with a network 32.

PCI Express controller 18 coordinates with an SMI error handler 34 to manage errors that occur in the communication of information across PCI Express link 24. In the event of a non-fatal error, meaning an error that makes a transaction across link 24 unreliable while link 24 itself remains fully functional, PCI Express controller 18 initiates an interrupt to SMI error handler 34. Upon receiving the interrupt, SMI error handler 34 identifies the event source to determine the component associated with the non-fatal error and provides the non-fatal error information to a PCI Express non-fatal error monitor 36. Non-fatal error monitor 36 compares the detected error with a predetermined condition to determine whether or present a non-fatal error message 38 or take other action. For example, non-fatal error monitor 36 counts the non-fatal errors associated with each component and issues an error message if the number of errors associated with a component exceeds a threshold. Non-fatal error monitor 36 issues the error message through BIOS 22 for presentation by the operating system of information handling system 10, such as to system management applications and drivers, and through IPMI link 30 to BMC 28 for communication over network 32, such as to server management applications like OMSA. The threshold at which an error message issues is variably set, such as at a number of errors in a given time point that indicates a pending system failure.

In one embodiment, the PCI Express non-fatal error monitor adapts to the Windows Hardware Error Architecture (WHEA) and PCI Express Advanced Error Reporting (AER). PCI Express non-fatal error monitor 36 queries components and drivers to determine compatibility with WHEA and AER. If an AER compatible root port and AER root driver are available at both ends of a PCI Express link, the AER aware drivers are allowed to take responsibility to set component control registers to enable AER. Enabling AER provides a more robust error reporting capability for stronger error handling if the capability is present. If AER is not present at both ends of a PCI Express link, PCI Express non-fatal error monitor 36 remains active to monitor for non-fatal errors.

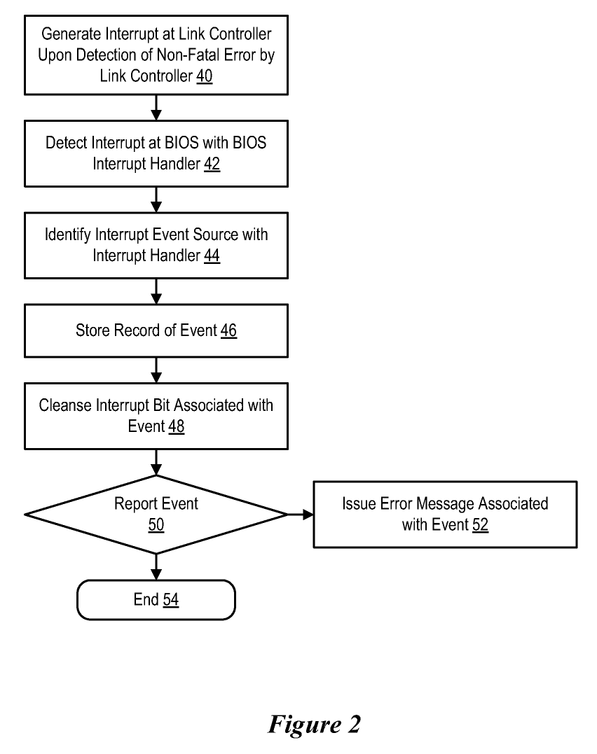

Referring now to FIG. 2, a flow diagram depicts a process for managing non-fatal errors associated with an information handling system link. The process starts at step 40 by generation of an interrupt at a link controller upon detection of a non-fatal error by the link controller. At step 42, the interrupt is detected by firmware of the information handling system, such as the BIOS, with an interrupt handler, such as an SMI error handler. At step 44, the interrupt handler identifies the event source for the error to determine the component associated with the error. At step 46, the interrupt handler stores a record of the event to track the error and the component associated with the error. At step 48, the interrupt bit associated with the error event is cleansed to permit continued monitoring for subsequent events. At step 50, a determination is made of whether to report the error event. For example, a decision to report the error is made if a predetermined number of non-fatal errors have occurred that are associated with the same component. If a decision to issue an error report is made, the process continues to step 52 to issue an error message, such as for presentation at a display or communication through a network to a management application, and the process ends at step 54. If a decision is made not to report the event, the process ends at step 54.

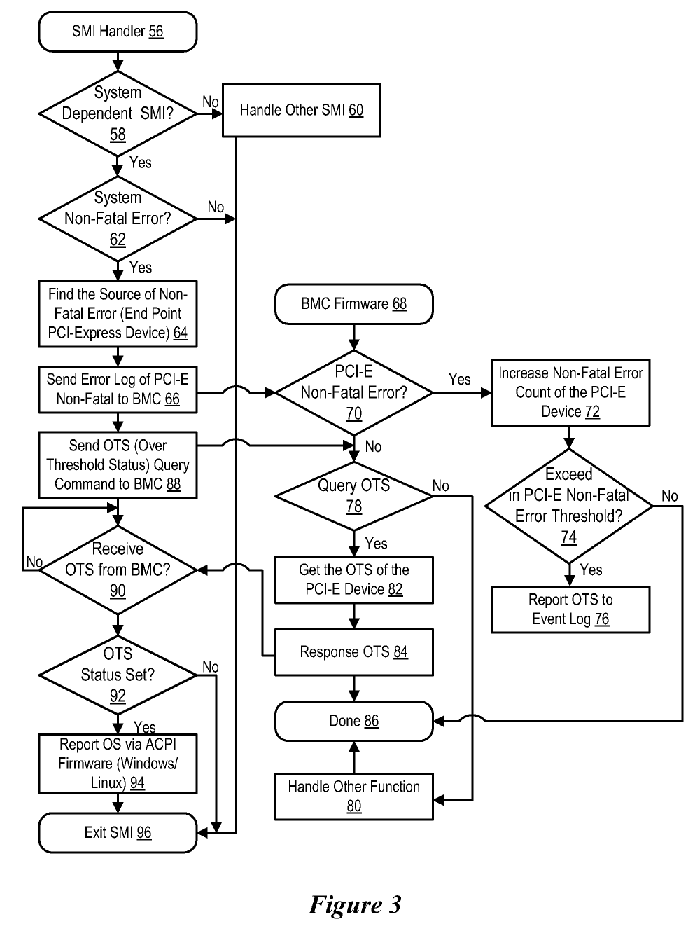

Referring now to FIG. 3, a flow diagram depicts a process for managing non-fatal errors of a PCI Express link by a blade server information handling system BIOS and operating system. The process starts at step 56 with detection of an interrupt by the SMI handler. At step 58, a determination is made of whether the interrupt is a system dependent SMI and, if not, the process continues to step 60 to handle the system independent SMI with SMI error handling and to exit SMI at step 96. If the SMI is system dependent, the process continues to step 62 to determine if the error is a non-fatal error and, if not, the process ends at step 96 with exit from SMI error handling. If the error is determined a non-fatal error, the process continues to step 64 to find the source of the non-fatal error, such as the end point PCI Express device associated with the error source event. At step 66, an error log of the PCI Express non-fatal error is sent to the BMC.

Error log management for non-fatal errors starts at step 68 with BMC firmware which, at step 70, determines if the error reported by the SMI error handler is a PCI Express non-fatal error. If the non-fatal error is a PCI Express non-fatal error, the process continues to step 72 to incrementally increase the non-fatal error count of the PCI Express component end point device associated with the error event. At step 74, a determination is made of whether the error count exceeds the PCI Express non-fatal error threshold. If the non-fatal error threshold is exceeded, the over threshold status is reported and the process is done at step 86. If the non-fatal error threshold is not exceeded at step 74, the process at the BMC is done at step 86. If at step 70 a determination is made that the error is not a PCI Express non-fatal error, the process continues to step 78 to query the over threshold status. If the threshold is not exceeded, the process continues to step 80 to handle the error according to the appropriate error function and BMC operations are done at step 86. If the threshold is exceeded, the process continues to step 82 to the get over threshold status of the PCI Express device and to respond to the SMI handler with the over threshold status at step 84, which completes processing at the BMC at step 86.

At step 66, in addition to proceeding through BMC processing, the process continues to step 88 to send an over threshold status query command to the BMC. The process waits at step 90 until a response is received from the BMC and, once a response is received to the query, the process continues to step 92. At step 92 a determination is made of whether the over threshold status is set. If the threshold is not exceeded, the process continues to step 96 to exit SMI error handling. If at step 92 the threshold is exceeded, the process continues to step 94 to report the over threshold status to the operating system via ACPI firmware. Once the over threshold status is reported for management by the operating system, the process ends at step 96 with exit from the SMI error handling.

Although the present invention has been described in detail, it should be understood that various changes, substitutions and alterations can be made hereto without departing from the spirit and scope of the invention as defined by the appended claims.

What is claimed is:

1. An information handling system comprising:
plural processing components operable to process information;
firmware running on a processing component, the firmware operable to coordinate operation of the processing components;
a link interfacing at least some of the processing components;
a link controller operable to manage communication of information over the link between the processing components and to issue an interrupt if a non-fatal error occurs with the communication of information; and
a non-fatal error monitor associated with the firmware and interfaced with the link controller, the non-fatal error monitor operable to receive the interrupt associated with the non-fatal error and to issue an error message if the non-fatal error meets predetermined condition.

2. The information handling system of claim 1 wherein the predetermined condition comprises a predetermined number of non-fatal errors.

3. The information handling system of claim 1 further comprising an error handler associated with the firmware and operable to handle errors associated with the processing components, the error handler further operable to identify a processing component associated with the non-fatal error.

4. The information handling system of claim 3 wherein the predetermined condition comprises a predetermined number of non-fatal errors associated with the identified processing component.

5. The information handling system of claim 4 wherein the error handler message comprises communication over a network.

6. The information handling system of claim 4 wherein the error handler message comprise a visual image presented at a display.

7. The information handling system of claim 1 wherein the link comprises a PCI Express link and the link controller comprises a PCI Express controller.

8. The information handling system of claim 7 wherein the error handler comprises an SMI error handler.

9. A method for managing non-fatal errors detected at an information handling system link, the method comprising:
detecting a non-fatal error at a link controller;
issuing an interrupt from the link controller;
receiving the interrupt at an interrupt handler;
determining with the interrupt handler that the non-fatal error meets a predetermined condition; and
issuing an error message from the interrupt handler for the non-fatal error.

10. The method of claim 9 wherein the interrupt handler comprises an SMI handler and issuing an error message comprises issuing an error message to an operating system of the information handling system.

11. The method of claim 9 wherein the link controller comprises a PCI Express link controller.

12. The method of claim 9 further comprising identifying a component of the information handling system that is associated with the non-fatal error.

13. The method of claim 12 further comprising counting the number of errors associated with one or more components.

14. The method of claim 13 wherein the predetermined condition comprises a predetermined number of errors associated with a component.

15. The method of claim 9 further comprising reporting the non-fatal error to a BMC.

16. A system for tracking non-fatal errors associated with an information handling system link, the system comprising:
a link controller operable to detect a non-fatal error associated with the link and to issue an interrupt; and
a link non-fatal error monitor interfaced with the link controller and operable to receive the interrupt and to issue an error message if the non-fatal error meets a predetermined condition.

17. The system of claim 16 wherein the predetermined condition comprises a predetermined number of non-fatal errors.

18. The system of claim 16 wherein the link non-fatal error monitor is further operable to determine a component associated with the non-fatal error and the predetermined condition comprises a predetermined number of non-fatal errors associated with the component.

19. The system of claim 16 wherein the link comprises a PCI Express link and the link controller comprises a PCI Express link controller.

20. The system of claim 16 wherein the link non-fatal error monitor error message comprises a message to an operating system of the information handling system.
